(19) United States
(12) Patent Application Publication
(10) Pub. No.: US 2009/0164780 A1
(43) Pub. Date: Jun. 25, 2009

(54) VOLUME MANAGEMENT METHOD IN A STORAGE APPARATUS HAVING ENCRYPTION FEATURE

(75) Inventors: Koichi Murayama, Kawasaki (JP); Nobuyuki Osaki, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: Hitachi, Ltd., Tokyo (JP)

(21) Appl. No.: 12/043,612

(22) Filed: Mar. 6, 2008

(30) Foreign Application Priority Data
Dec. 19, 2007 (JP) 2007-326698

(51) Int. Cl. H04L 9/00

(52) U.S. Cl. 713/165

(57) ABSTRACT

The invention provides a computer system including a storage apparatus having an encryption feature, a management computer for running a management program for managing the storage apparatus, and an application host computer, wherein when allocating a logical volume or creating a copy pair, the management program selects, from the storage apparatus, a logical volume that satisfies a security level required by an application program that uses the logical volume to allocate the logical volume or create a copy pair.

### CROSS-REFERENCES TO RELATED APPLICATIONS

This application relates to and claims priority from Japanese Patent Application No. 2007-326698, filed on Dec. 19, 2007, the entire disclosure of which is incorporated herein by reference.

### BACKGROUND

1. Field of the Invention

The invention relates generally to a method for managing a volume in a storage apparatus having a stored data encryption feature.

2. Description of Related Art

In recent years, interest in security measures such as data protection and protection against unauthorized access have been enhanced. Important information such as workers' personal information and clients' information is stored in storage apparatuses used in companies, and technology for protecting the data stored in those storage apparatuses is necessary. JP2005-322201 A discloses a technique for encrypting data in a storage apparatus. With that technique, data recorded in storage media HDD or similar devices included in a storage apparatus is encrypted, so the risk of leakage of the data should that storage media be stolen is reduced.

Meanwhile, a storage administrator has to provide logical volumes made up of HDD or similar devices. JP2005-322201 A discloses a method for rearranging logical volume based on IO performance.

To form a copy pair between a primary logical volume and a secondary logical volume, a storage administrator has to select an appropriate secondary volume. JP2004-246852 A discloses a method for selecting a secondary logical volume so that the secondary logical volume fulfills requirements required by the relevant primary volume.

The encryption levels provided by storage apparatuses or the environment that surrounds storage apparatuses vary, so it is necessary to appropriately protect the security level according to the importance of the relevant data.

The technique disclosed in JP2005-322201 A enables enhancement of a security level by encrypting data stored in a storage apparatus. However, as described above, the encryption levels provided by storage apparatuses or the environment surrounding storage apparatuses vary. In particular, JP2005-322201 A has no disclosure regarding protecting security levels according to data importance in a computer system including plural storage apparatuses.

The technique disclosed in JP2005-234834 A enables logical volume rearrangement. However, security measures require the security level to be kept from the beginning when the logical volumes are provided, so problems concerning security cannot be solved by rearranging information obtained afterward.

The technique disclosed in JP2004-246852 A enables, when forming a copy pair, selection of a copy destination logical volume so that requirements required for a copy source logical volume are fulfilled. However, in a configuration where a copy pair is formed with a copy source logical volume and a copy destination logical volume, the security level may differ between the environments surrounding the storage apparatuses having the copy source logical volume and the copy destination logical volume. In that case, for example, if the copy source-side storage apparatus is in a sufficiently secure environment, or, more specifically, if who can physically access the storage apparatus is limited, in some cases even important data that requires high security level is stored without being encrypted in the copy source-side storage apparatus, and encryption may be conducted only in the copy destination-side storage apparatus. In that system, if a copy destination logical volume is selected to fulfill the requirements required for the copy source logical volume, unencrypted data may be stored in the above selected copy destination volume with the same encryption status as that of the copy source logical volume, and, as a result, data is stored in the copy destination-side storage apparatus even though the copy source destination-side apparatus is not in a sufficiently secure environment, so the required security level cannot be guaranteed. In addition, if, for some reason (for example, all free areas are encryption areas), an encryption area in a copy source-side storage apparatus is allocated to a copy source logical volume in an application program in which data encryption is originally unnecessary, the encryption level in the copy source logical volume is higher than that required by the data to be stored. In that case, if a copy source logical volume is selected to fulfill the requirements required for the copy source logical volume, a volume with high encryption level is allocated to the copy destination logical volume, so data that can originally be stored in a logical volume with a low encryption level is stored in the logical volume with a high encryption level. Therefore, areas in the storage apparatus cannot be efficiently used and apparatus performance deteriorates.

### SUMMARY

The invention was made in light of the above situations, and its first object is to allocate, to a host computer, a logical volume that appropriately guarantees a security level according to data importance.

The second object of the invention is to select, in a configuration in which a copy pair is created, a copy destination logical volume that appropriately guarantees a security level according to data importance.

To achieve the first object, in the invention, memory in a management computer stores information about a security level required by an application program that operates in each of plural host computers and information about a security level in each logical volume included in a storage apparatus, and when receiving a logical volume allocation request, the management computer selects and allocates a logical volume that satisfies the security level required by a relevant application program.

To achieve the second object, in the invention, memory in a management computer stores information about an application program that uses each logical volume included in a storage apparatus, information about a security level required by an application program that runs on each of the plural host computers, and information about a security level in each logical volume included in a storage apparatus, and when receiving a copy pair creation request, the management computer selects, as a copy destination logical volume, a logical volume that satisfies the security level required by an application program that uses a copy source logical volume, and creates a copy pair.

In other words, to maintain a security level according to data importance, the security level required by each application program that runs on a host computer is managed, and a logical volume is selected based on the security level required by the relevant application program. With that configuration, compared with a conventional computer system including plural storage apparatuses having different encryption levels or placed in different environments, in this invention logical volumes included in each storage apparatus can be used, while guaranteeing a security level.

With the invention, a security level can be appropriately guaranteed according to data importance.

Other aspects and advantages of the invention will be apparent from the following description and the appended claims.

### BRIEF DESCRIPTION OF THE DRAWINGS

FIG. 1 is a schematic diagram illustrating a configuration for a computer system in an embodiment of the invention.

FIG. 2 is a diagram illustrating a configuration for modules in a security level management program in an embodiment of the invention.

FIG. 3 is a diagram illustrating an example of a storage apparatus management table in an embodiment of the invention.

FIG. 4 is a diagram illustrating an example of a security level definition table in an embodiment of the invention.

FIG. 5 is a diagram illustrating an example of a logical volume management table in an embodiment of the invention.

FIG. 6 is a diagram illustrating an example of an application security level management table in an embodiment of the invention.

FIG. 7 is a diagram illustrating an example of a storage apparatus management table in an embodiment of the invention.

FIG. 8 is a diagram illustrating an example of an encryption level encryption level definition table in an embodiment of the invention.

FIG. 9 is a diagram illustrating an example of a security level definition table in the case where an encryption level in an embodiment of the invention is used.

FIG. 10 is a diagram illustrating a summary of processing in an embodiment of the invention.

FIG. 11 is a diagram illustrating an example of processing for registering a storage apparatus in an embodiment.

FIG. 12 is a diagram illustrating an example of processing for updating security level definition in an embodiment of the invention.

FIG. 13 is a diagram illustrating an example of processing for updating a logical volume management table in an embodiment of the invention.

FIG. 14 is a diagram illustrating an example of processing for registering an application program in an embodiment of the invention.

FIG. 15 is a diagram illustrating an example of processing for primary logical volume allocation in an embodiment of the invention.

FIG. 16 is a diagram illustrating an example of processing for secondary logical volume allocation in an embodiment of the invention.

FIG. 17 is a diagram illustrating an example of processing for transferring encrypted data in an embodiment of the invention.

FIG. 18 is a diagram illustrating an example of a logical volume management table that also includes performance level in an embodiment of the invention.

FIG. 19 is a diagram illustrating an example of an application service level management table in an embodiment of the invention.

FIG. 20 is a diagram illustrating an example of processing for primary logical volume allocation conducted, taking a performance level into consideration, in an embodiment of the invention.

### DETAILED DESCRIPTION OF PREFERRED EMBODIMENTS

Embodiments of the invention will be described below with reference to the drawings.

### Embodiment 1

1. System Configuration in this Embodiment

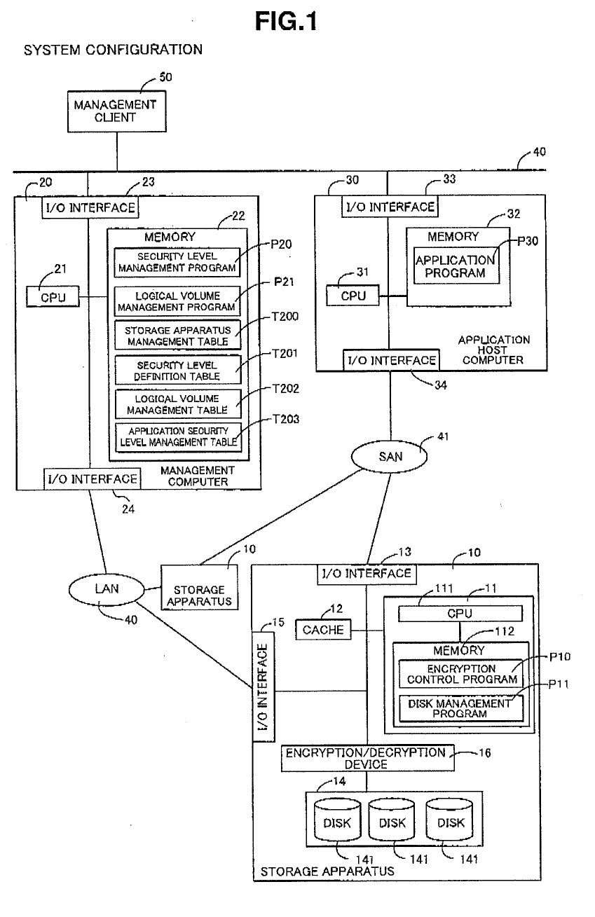

FIG. 1 is a diagram illustrating a schematic configuration for a computer system in this embodiment. This computer system includes storage apparatuses 10, a management computer 20, an application host computer 30, and a management client 50. In this embodiment, two storage apparatuses 10, a management computer 20, a application host computer 30, and a management client 50 are used, but any number of those components can be used The storage apparatuses 10, the management computer 20, the application host computer 30, and the management client 50 are connected to a management network 40. The application host computer 30 is connected to the storage apparatuses 10 via a data network 41 such as a SAN (storage Area Network).

Each storage apparatus 10 provides the application host computer 30 with a storage area (logical volume), and includes a disk array controller 11, a cache 12, a data I/O interface 13, plural disk devices 14, a management I/O interface 15, and an encryption/decryption device 16. The disk array controller 11 is a control module for executing various kinds of processing for controlling the storage apparatuses 10, and has a CPU 111, memory 112, and an I/O port. The cache 12 temporarily stores data to be written to the disk devices 14, or data read from the disk devices 14. The disk devices 14 is a disk array device including plural magnetic hard disk drives formed in a RAID configuration. Plural disk drives 141 provide one or more logical devices (LDEV(s)), or a single hard disk drive provides one or more storage areas, i.e., logical devices (LDEV(s)).

The encryption/decryption device 16 encrypts, based on encryption status established by an encryption control program P10, data to be written to the disk devices 14, or decrypts data read from the disk devices 14. In this embodiment, a single encryption algorithm can be set in one storage apparatus 10, and whether or not encryption is enabled can be selected for each LDEV, but a storage apparatus in which an encryption algorithm can be changed for each LDEV may alternatively be available. If an encryption feature is available in a storage apparatus 10 and encryption for the LDEV(s) is enabled, the encryption/decryption device usually encrypts data before storing the data during data writing, and decrypts data during data reading. Meanwhile, when copying data to another storage apparatus that does not have the encryption feature, the encrypted data to be transferred to the copy destination apparatus is not decrypted.

The memory 112 stores an encryption control program P10 and a storage management program P11. The encryption control program P10 sets an encryption mode for the storage apparatus in response to a request from the management computer 20, and controls whether or not to encrypt data to be stored in logical volumes. In this embodiment, a single encryption mode can be set in each storage apparatus 10 and the encryption is enabled/disabled for each logical volume. However, settings for the encryption can be established in other units, e.g., different encryption modes may be set for each logical volume.

The storage management program P11 is a program for executing various management features provided by the storage apparatus 10, e.g., creating, in response to a request from the management computer 20, an LU (Logical Unit), allocating an LU provided by the disk devices 14 to the application host computer 30, and copying data in an LU to another LU provided by the storage apparatus 10.

An LU, being formed by one or plural LDEV(s), is a unit of a storage area recognized by applications that operate in a host computer. A logical volume is a logical storage area provided by one or plural disk drive(s), and includes an LDEV(s) and LU(s).

The management computer 20 executes management operations for the storage apparatuses 10, e.g., creation of logical volumes in a storage apparatus, allocation of logical volumes to the host computer, logical volume migration, and replication in a storage apparatus or between storage apparatuses. The management computer 20 includes a CPU 21, memory 22, a front-end I/O interface 23, and a rear-end I/O interface 24. The CPU 21, memory 22, front-end I/O interface 23, and rear-end I/O interface 24 are connected mutually via a bus. The CPU 21 is a processing unit for executing various programs stored in the memory 22. The memory 22 is a so-called internal storage device and includes both nonvolatile memory for storing various modules and volatile memory for temporarily storing operation processing results.

The memory 22 stores a security level management program P20, a logical volume management program P21, a storage apparatus management table T200, a security level definition table T201 that contains encryption modes set in the storage apparatuses 10, a logical volume management table T202, and an application security level management table T203.

The security level management program P20 manages a security level in each logical volume provided by the storage apparatuses 10 and the security level required by each application program P30 that uses logical volumes provided by the storage apparatuses 10.

The logical volume management program P21 requests, in response to a request from the management client 50, that the storage management program P11 in each storage apparatus 10 create or allocate a logical volume. The storage apparatus management table T200 manages an encryption feature provided by each storage apparatus 10 and the risk of theft of the storage apparatus 10. The security level definition table T201 is used to determine a security level in each logical volume in the storage apparatus 10 based on the encryption mode set in each storage apparatus 10 and the risk of theft of the storage apparatus 10. The logical volume management table T202 manages the relationship between the security level in each logical volume and the application host computer 30 the logical volume is allocated to. The application security level management table T203 is a table for managing a security level required by data handled by the application program P30.

The application host computer 30 runs application programs P30 such as a database management system (DBMS) or backup programs, writes processing results to the storage apparatus(s) 10, or utilizes information resources stored in the storage apparatus 10. Regarding communication protocols, Fibre Channel protocol or iSCSI is used for a SAN. The application host computer 30 has the same configuration as that of the management computer 20, so the explanation has been omitted. The details for each table will be described later.

The management client 50 executes, in response to a request from a user, GUI or CLU for sending the request to the programs that run in the management computer 20, or receiving a management program execution result and displaying the result to the user. The management client 50 has the same configuration as that of the management computer 20, so the explanation has been omitted.

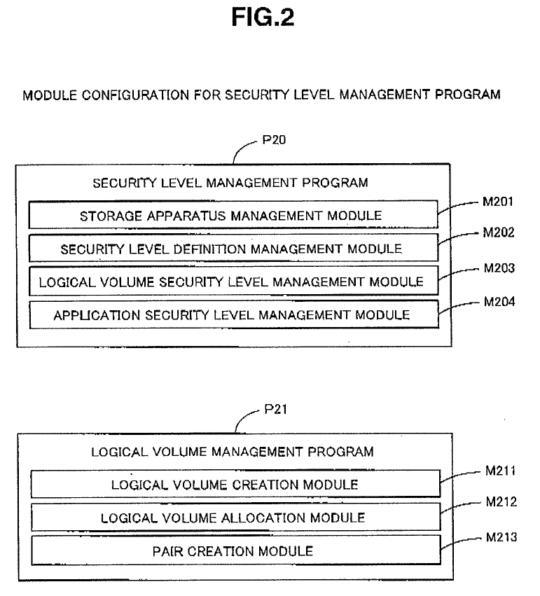

The details of the programs and tables stored in the memory 22 in the management computer 20 will be described below with reference to FIGS. 2 to 6.

FIG. 2 is a diagram illustrating module configurations of the security level management program P20 and the logical volume management program P21.

The security level management program P20 contains a storage apparatus management module M201, a security level definition management module M202, a logical volume security level management module M203, and an application security level management module M204.

The storage apparatus management module M201 is a module for managing information the storage apparatus(es) has, and updates, in response to a request from the management client 50, information contained in the storage apparatus management table T200.

The security level definition management module M202 is a module for managing definition of security levels. The security level definition management module M202 monitors the update status of the storage apparatus management table T200, and reflects, if the storage apparatus management table T200 is updated, in the security level definition table T201, the values of an “encryption mode” entry and a “theft risk” entry in the storage apparatus management table T200. The security level definition management module M202 also updates, in response to a security level definition update request from the management client 50, the security level in the security level definition table T201.

The logical volume security level management module M203 is a module for managing a security level in each logical volume, and updates, based on an encryption status in each storage apparatus, security level definition, and the encryption status in each logical volume, the security level managed in the logical volume management table T202.

The application security level management module M204, in response to a request from the management client 50 registers, information contained in the application program P30 and information about the application host computer where application programs run in the application security management table T203.

The logical volume management program P21 contains a logical volume creation module M211, a logical volume allocation module M212, and a pair creation module M213.

The logical volume creation module M211 is a module for creating or deleting logical volumes in the storage apparatuses 10. The logical volume creation module M211 communicates, in response to a logical volume creation request from the management client 50, with the storage management program P11 in each storage apparatus 10 and creates or deletes a logical volume in the storage apparatus 10. The logical volumes created in the storage apparatus 10 are registered in the logical volume management table T202. For example, if a request is made for a storage apparatus 10 to create from LDEV1:2 and 1:3 two logical volumes that do not need to be encrypted and LU 102 and LU 103 are created as a result, LU 102 and LU 103 are registered in the entries for LDEV1:2 and 1:3 in the logical volume management table T202, and an “encryption status” entry is set to “OFF”, an “encryption mode” entry to “N/A”, a “security level” entry to “A” corresponding to the combination of the encryption made of “N/A” and the theft risk of a storage apparatus 1 of “Low” in the security level definition table T201, and an “application program name” entry to “−” since no logical volume has been allocated. When deleting a logical volume, the logical volume specified by a storage apparatus 10 is deleted and the information about the deleted logical volume is deleted from the logical volume management table T202 to set the table back to the state of “LDEV”.

The logical volume allocation module M212 is a module for allocating a logical volume to the application host computer 30 or canceling that allocation. The logical volume allocation module M212 allocates, in response to a logical volume allocation request from the management client 50, a logical volume from a storage apparatus 10 to the application host computer 30 where the application program 20 runs, then enters the host name of the application host computer 30 in the “host” entry corresponding to the above allocated logical volume in the logical volume management table T202, and enters the name of the application program the logical volume is allocated to in the “application program name” entry. When cancelling the allocation, the allocation of the logical volume from the storage apparatus 10 is cancelled, and the “host” and “application program name” entries are set to “−”.

The pair creation module M213 is a module for creating a copy pair of logical volumes allocated to an application program, or deleting the thus-created copy pair. The pair creation module M213 creates, in response to a pair creation request from the management client 50, a logical volume (secondary logical volume) that satisfies the security level required by an application program that uses a copy source logical volume (primary logical volume), then forms a copy pair. When deleting a copy pair, the pair state of the secondary logical volume in the specified copy pair is released, and the status of the secondary logical volume is set back to an LDEV.

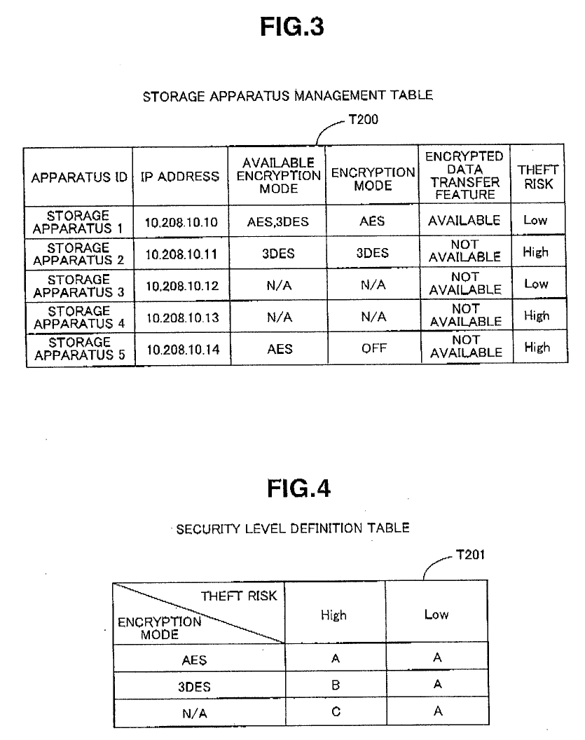

An example of the storage apparatus management table T200 stored in the memory 22 in the management computer 20 is described with reference to FIG. 3. The storage apparatus management table T200 is a table for managing the encryption feature provided by the storage apparatuses 10 and the theft risk of the storage apparatuses 10, and is used by the security level management program P20 and the logical volume management program P21. The storage apparatus management table T200 has “apparatus ID”, “IP address”, “available encryption mode, “encryption mode”, encrypted data transfer feature” and “theft risk” entries.

The “apparatus ID” entry holds an ID for specifying the storage apparatus 10 to be managed. The “IP address” entry holds the transmission target for a request for execution of each program in the storage apparatuses 10. The “available encryption mode” entry holds the encryption feature provided by the storage apparatuses 10. In the FIG. 3 example, the encryption algorithm name is stored “N/A” means no encryption feature being provided by the storage apparatuses 10. If a storage apparatus 10 provides plural encryption modes, the encryption modes are shown, separated with a comma like “AES, 3DES”. The “encryption mode” entry holds the current status of the encryption status in the storage apparatuses 10. If the encryption mode is set to ON, one of the values held by the “available encryption mode” entry is entered in the “encryption mode” entry. If the encryption mode is not set to ON, “OFF” is entered. If the encryption feature is not provided, “N/A” is entered. The “encrypted data transfer function” entry holds whether or not each storage apparatus 10 has a feature copying encrypted data in a logical volume to a logical volume included in another storage apparatus 10 while maintaining the encrypted state of that data. That feature is hereinafter referred to as an “encrypted data transfer feature”. If the storage apparatus 10 has the encrypted data transfer feature, “available” is entered in the “encrypted data transfer function” entry. Otherwise, “not available” is entered. The “theft risk” entry indicates the risk of each storage apparatuses 10 being stolen. In the FIG. 3 example, “high” is entered if the theft risk is high, and “low” is entered if the theft risk is low. A user may make the definition segmentation for values entered in the “theft risk” entry more detailed if necessary by, for example, adding “Middle”.

An example of the security level definition table T201 stored in the memory 22 in the management computer 20 is described with reference to FIG. 4. The security level definition table T201 is a table for determining, based on the encryption mode set in the storage apparatus 10 and the theft risk of the storage apparatus 10, the security level in each logical volume provided by the storage apparatuses 10, and is used by the security management program P20 and the logical volume management program P21.

The “encryption mode” entry indicates the encryption modes set for each logical volume, and holds any of the encryption modes registered in the “available encryption mode” entries in the storage apparatus management table T200. The “theft risk” entry indicates the risk of each storage apparatuses 10 being stolen, and holds any of the values registered in the “theft risk” entries in the storage apparatus management table T200. The “security level” determined based on the combination of the “encryption mode” entry and the “theft risk” entry is defined as “A”, “B” or “C” in descending order of security level, but is initially set to “C”, indicating the lowest security level. A user updates the definition based on their security policy.

In the FIG. 4 example, if the “encryption mode” set in a storage apparatus 10 is “3DES” the encryption settings are established so that data is encrypted before being stored in a logical volume and the theft risk in that storage apparatus 10 is “High”, it means that the security level in a logical volume provided by the storage apparatus 10 is “B”.

In this embodiment, the security level is determined based on both the “encryption mode” entry and the “theft risk” entry, but may alternatively be determined by either of those entries alone.

Moreover, the security level may also be determined by other entries, or a combination of those “encryption mode” and “theft risk” entries and other entries.

In some cases the storage apparatuses might be located in different environments. Evaluating those environments for “theft risk” is a unique feature particularly in terms of security measures.

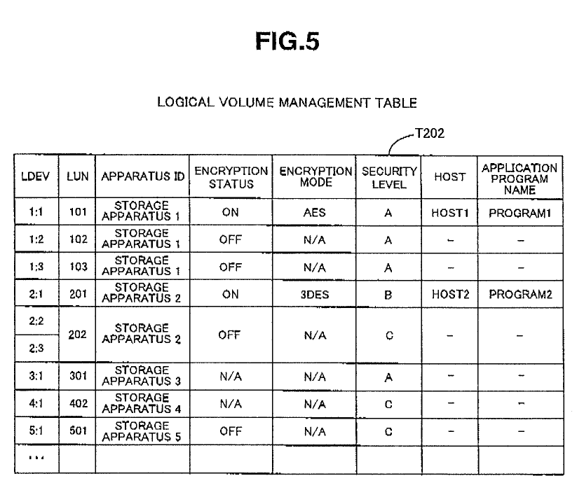

An example of the logical volume management table T202 stored in the memory 22 in the management computer 20 is described below with reference to FIG. 5. The logical volume management table T202 is a table for managing the correspondence between LDEVs and logical volumes, the security level in each logical volume, and the application host computer 30 each logical volume is allocated to. The logical volume management table T202 contains entries for “LDEV”, “LUN”, “apparatus ID”, “encryption status”, “encryption mode”, “security level”, “host” and “application program name”

The “LDEV” entry holds an ID for specifying each LDEV provided by the disk devices 14 in the storage apparatuses 10. The “LUN” entry holds an ID for specifying each logical volume created from an LDEV. The “apparatus ID” holds an ID for specifying the storage apparatus 10 each logical volume belongs to, and the same values as those held by the “apparatus ID” entries in the storage apparatus management table T200 are entered. The “encryption status” entry indicates if encryption of the logical volumes is enabled/disabled. If the “encryption status” entry is “ON” data is encrypted before being stored. If this entry is “OFF” data is not encrypted before being stored. The “encryption mode” entry holds the encryption mode that is finally applied to each logical volume. If the “encryption status” entry is “ON” the encryption mode set for the storage apparatus 10 the relevant logical volume belongs to is entered in this “encryption mode” entry. Meanwhile, if the “encryption status” entry is “OFF” or “N/A,” “N/A” is entered in the “encryption mode” entry. The “security level” entry indicates a security level in each logical volume, and holds a security level determined based on the “encryption mode” entry and “theft risk” entry set for the storage apparatus 10 the relevant logical volume belongs to, and the value in the “encryption status” entry for the logical volume. The “host” entry holds an identifier for the host computer each logical volume is allocated to. If no logical volume is allocated to the host computer, “−” is entered. The “application program name” entry holds the application program that uses each logical volume. If no logical volume is allocated to the host computer, “−” is entered.

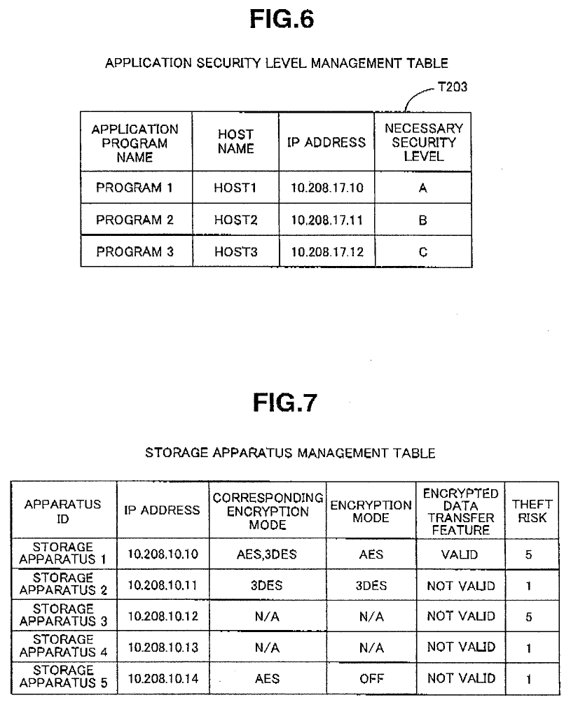

An example of the application security level management table T203 stored in the memory 22 in the management computer 20 is described with reference to FIG. 6. The application security level management table T203 is a table for managing security levels required by data handled by the application program P30, and is used by the security management program P20 and the logical volume management program P21. The application security level management table T203 contains entries for “application program name” “host name” “IP address” and “necessary security level”.

The “application program name” entry holds a name for specifying an application program. The “host name” entry holds a name of a host computer where a relevant application program runs. The “IP address” entry holds an IP address of the application host computer where the application program runs. The “required security level” entry holds a security level required by data handled by the application program, and any of values indicating the security levels defined in the security level definition table is entered in this “required security level” entry. The host names and IP addresses registered in this table may be not only values indicating physical application host computer 30, but also values indicating virtualized computers.

In the above explanation, a single encryption mode is set in a storage apparatus 10 and the encryption status is switched for each LDEV. However, if a different encryption mode can be set to each LDEV, the “encryption mode” entry in the storage apparatus management table T200 is not used, and the encryption mode set for an LDEV is directly entered in the “encryption mode” entry in the logical volume management table T202.

If the encryption mode can be set for a unit larger than a logical volume, such as a RAID group, the encryption mode set for a unit a relevant logical volume is entered in the “encryption mode” entry in the logical volume management table T202, like when an encryption mode is set for a storage apparatus 10.

In the explanation of FIGS. 3 and 4, the security level is determined by the combination of the encryption mode and the theft risk. However, as shown in FIGS. 7 to 9, the security level may also be determined by using digitalized value of the theft risk or encryption mode.

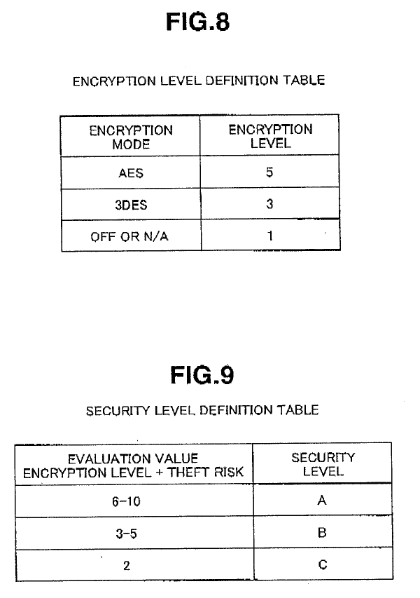

FIG. 7 shows a storage apparatus management table that contains digitalized value of theft risk. “1” is entered in the “theft risk” entry if the theft risk is high, and “5” is entered if the theft risk is low. FIG. 8 is a table for converting an encryption mode into an encryption level. The encryption level is defined in accordance with the strength of encryption algorithm. An encryption level of “1” is lowest, and “5” is highest. FIG. 9 is a security level definition table that contains digitalized values of encryption modes and theft risks. A security level is determined according to the sum of an encryption level value and a theft risk value. The security level is highest when the theft risk is low and the encryption level is high.

2. Operation in this Embodiment

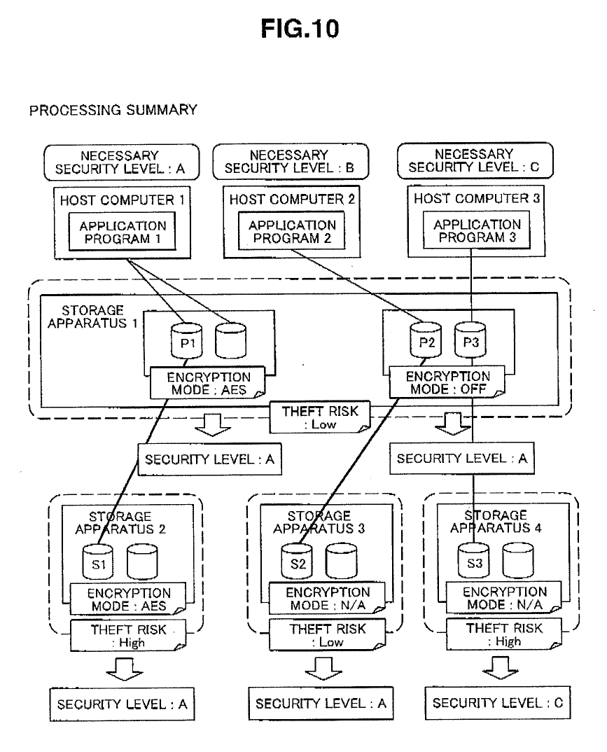

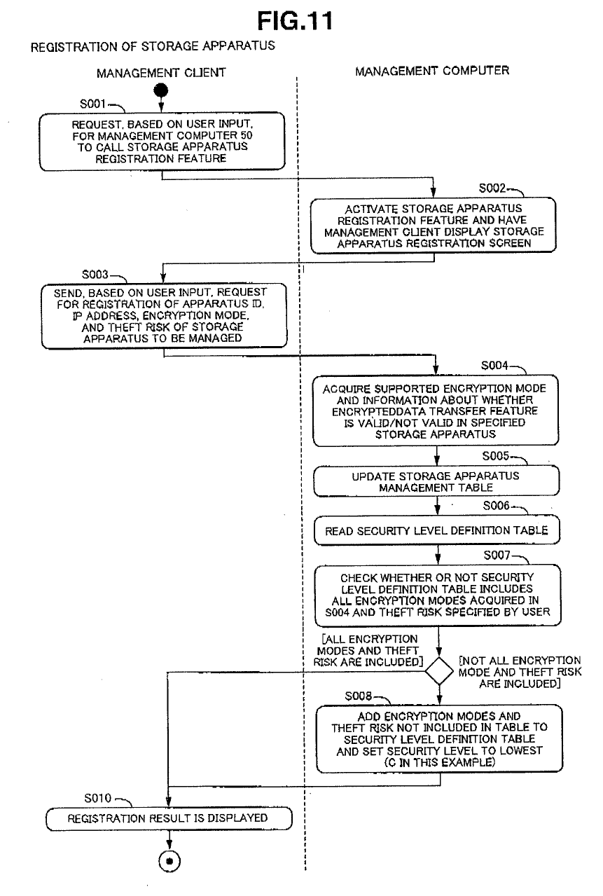

Next, operation in this embodiment will be described. The summary of this embodiment is described with reference to FIG. 10. The management computer 20 manages, based on the correspondence between the encryption mode currently set for the storage apparatus 10 to be managed and the theft risk in that storage apparatus 10, security levels in logical volumes provided by each of the storage apparatus 10. Regarding the application host computer 30, the management computer 20 manages the application programs P30 that runs on the application host computer 30 and the security level required by each application program P30.

When allocating a logical volume from a storage apparatus 10 to the application host computer 30, the management computer 20 allocates a logical volume that satisfies a security level required by the application program P30 in the application host computer 30 that uses the logical volume. When creating a copy pair, the management computer 20 selects, as a copy destination logical volume, a logical volume that satisfies the security level required by the application program that uses a copy source logical volume, and creates a copy pair using those logical volumes. If no logical volume satisfies the security level in the copy destination-side storage apparatus, the security level in the copy destination logical volume is maintained by storing encrypted data in a logical volume in the copy destination-side storage apparatus.

This process includes processing executed in the management computer 20 for registering a storage apparatus 101 defining a security level, determining a security level in each LDEV, registering a security level for a application program, allocating a logical volume to an application host computer 30 based on the security level, and creating a copy pair based on a security level.

The processing sequence in this embodiment will be described below with reference to FIGS. 11 to 17.

The sequence of processing for registering a storage apparatus 10 is described with reference to FIG. 11. This processing is executed for registering, in the management computer 20, information about the storage apparatus 10 managed by a user. The information input by a user to the management client 50 and the information acquired by the management computer 20 from the storage apparatus 10 are registered in the storage apparatus management table T200.

The management client 50 requires that the management computer 20 call a storage apparatus registration feature based on user input (S001). The security level management program P20 in the management computer 20 activates the storage apparatus registration function in response to the call request, and has the management client 50 display a storage apparatus registration screen (S002).

The user inputs, from the screen displayed by the management client 50, the “apparatus ID”, “IP address”, “encryption mode” and “theft risk” of the storage apparatus to be managed. The management client 50 sends a registration request to the management computer 20 based on the user input (S003). After receiving the registration request, the management computer 20 acquires, from the specified storage apparatus, encryption modes supported by the storage apparatus and information about availability of the encrypted data transfer feature (S004), and registers them in the storage apparatus management table T200 (S005).

Next, the management computer 20 reads the security level definition table T201 (S006), and checks whether or not all encryption modes acquired in S004 are held in the encryption mode entries in the security level definition table T201, and whether or not the theft risk set by the user in S003 is held in the theft risk entries in the security level definition table T201 (S007). If some encryption modes or the theft risk is not held in the security level definition table T201, the encryption modes or the theft risk not existing in the table is added to the security level definition table T201, the management computer 20 enters “C” in the security level entries corresponding to the above added encryption mode or the theft risk entries, and updates the security level definition table T201 (S008). Meanwhile, if all encryption modes and the theft risk are already held in the security level definition table T201, the processing proceeds to the next step.

Finally, the result of the storage apparatus 10 registration is displayed in the management client 50 (S010). If the registration processing is interrupted, an error message is displayed as the registration result.

Through the above processing the storage apparatus 10 to be managed and the information about security for the storage apparatus 10 is registered at the same time.

In this processing, a user registers the theft risk of the storage apparatus. However, if the weight of the storage apparatus 10, information about a HDD in the storage apparatus 10 being able to be locked and so accessed only by a limited number of people, and a security level in a datacenter that accommodates the storage apparatus are recorded as data and the management computer 20 can acquire that information, the theft risk may be automatically calculated based on those kinds of information.

In addition, in this embodiment, the management computer 20 acquires, from the storage apparatus 10, information about availability of the encryption modes supported by the storage apparatus 10 and the encrypted data transfer feature, but alternatively, a user may register those kinds of information.

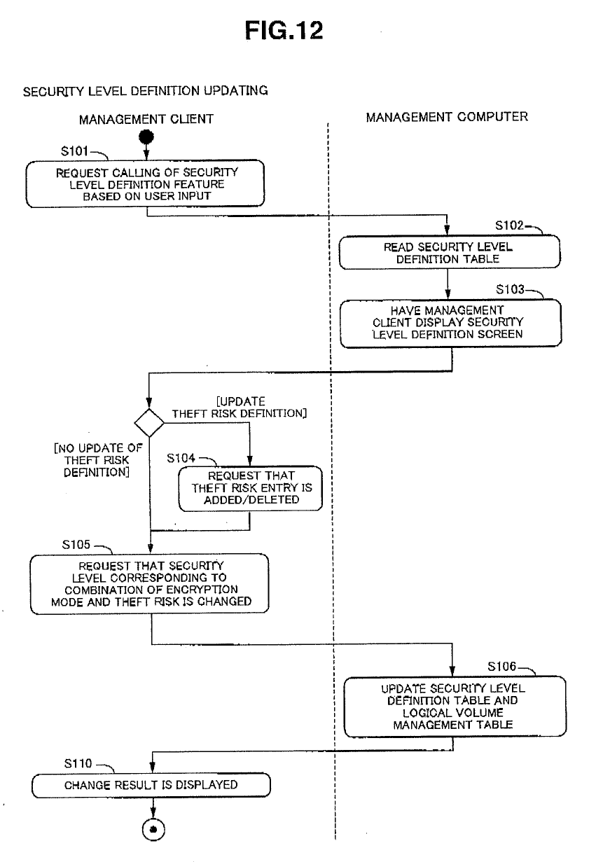

The sequence of processing for defining a security level is described below with reference to FIG. 12. In this processing, in response to a request from the management client 50 for receiving user input, a security level in each logical volume provided by the storage apparatuses is defined and the security level definition table T201 is updated based on theft risk of the storage apparatus and the encryption mode used in each logical volume provided by the storage apparatuses.

First, the management client 50 requests, based on user input, calling from the management client 50 of a security level definition feature in the security level management program P20 in the management computer 20 (S101), and the management computer 20 reads, after receiving the above request, the security level definition table T201 (S102) and has the management client 50 display a security level definition screen (S103).

When adding or deleting, based on user input, a theft risk to already defined theft risks, the management client 50 makes a request for management device to update the theft risk (S104). For example, this process is conducted when adding, as a theft risk, “Middle”, in addition to “High” and “Low”. Next, the management client 50 makes a request for the security level corresponding to the combination of a relevant encryption mode and theft risk to changed based on user input (S105). If the security level has not been set, “C” is set as the security level. The management computer 20 reflects the change in the security level definition table T201 (S106) after receiving the change request.

Finally, the change result is displayed in the management client 50 (S110). If the change processing failed halfway through, an error message is displayed as the change result.

Through the above processing, the security level definition is updated according to users security policy.

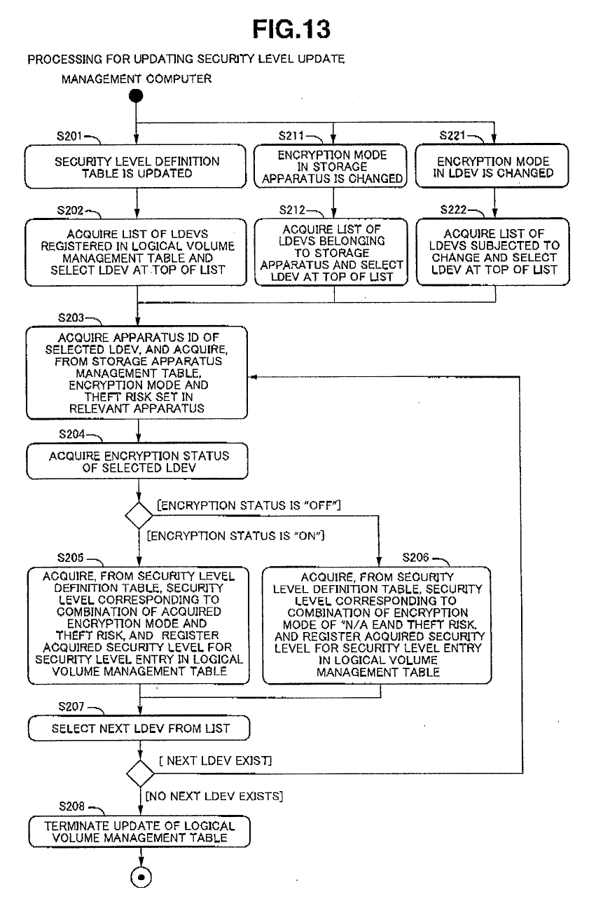

The sequence of processing for updating a security level registered in the logical volume management table is described with reference to FIG. 13. This processing is executed to determine the security level in each LDEV according to the encryption mode and theft risk of the storage apparatus 10. It is assumed that before this processing, an LDEV has been created in a storage apparatus 10 and the encryption status for each LDEV has been set to ON/OFF when forming a logical volume. When the LDEV is created and the encryption status is set to ON/OFF, the “LDEV”, “apparatus ID” and “encryption status” regarding the created LDEV are registered in the logical volume management table T202. An LDEV may be created by a user from the management console 50, or initially prepared in the storage apparatus 10.

This processing is conducted when the security level definition table T202 is updated, the encryption mode for a storage apparatus 10 is changed, or the encryption status in an LDEV are changed.

If the security level definition table is updated (S201), a list of LDEVs registered in the logical volume management table T202 is acquired, and the LDEV at the top of the list is selected (S202). If the encryption mode for a storage apparatus is changed (S211), a list of LDEVs belonging to that storage apparatus is acquired, and the LDEV at the top of the list is selected (S212). If encryption modes for LDEVs are changed (S221), a list of the LDEVs subjected to the change is acquired, and the LDEV at the top of the list is selected (S222).

Next, the apparatus ID corresponding to the above selected LDEV is acquired from the logical volume management table T202, and the encryption mode and theft risk set for that apparatus is acquired from the storage apparatus management table T200 (S203). The encryption status for that LDEV is also acquired from the logical volume management table T202 (S204).

If the above acquired encryption status is ON, the security level corresponding to the combination of the above acquired encryption mode and theft risk is acquired from the security level definition table T201 and registered in the “security level” entry in the logical volume management table T202 (S205). If the above acquired encryption status is OFF, the security level corresponding to the combination of the encryption mode of “N/A” and theft risk is acquired from the security level definition table T201 and registered in the “security level” entry in the logical volume management table T202 (S206).

After registration, the next LDEV is selected from the list (S207), and the processing of step S203 and subsequent steps is repeated. If a next LDEV does not exist, processing for updating security levels in the logical volume management table T202 terminates (S208).

Through the above described processing, the security level in LDEVs can be maintained in the latest state according to the change in the security level definition and encryption mode for LDEVs, and logical volumes are allocated to the host computer 30 based on that security level.

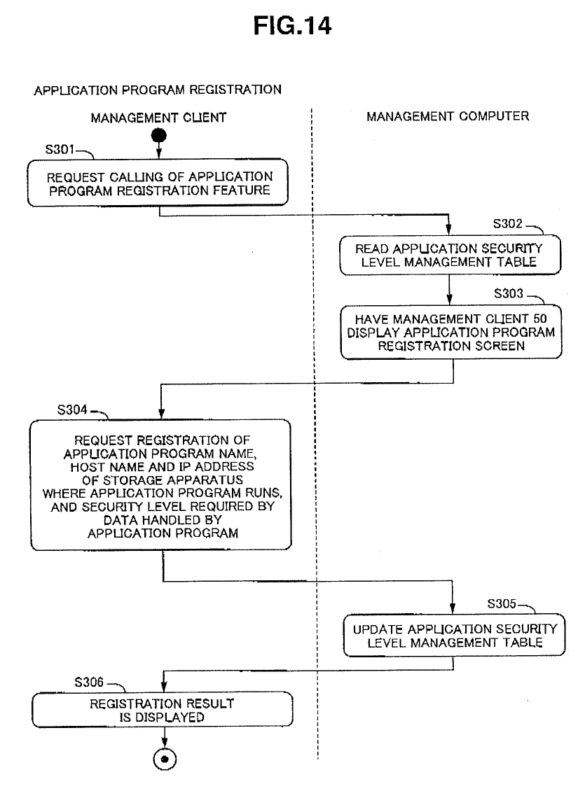

The sequence of processing for registering a security level required by each application program is described with reference to FIG. 14. This processing is conducted to register, for the management computer 20, information about the application host computer 30 a logical volumes in each storage apparatus 10 is allocated to and an application program that runs on that host computer.

The management client 50 requests, based on user input, calling of an application program registration feature in the security level management program P20 in the management computer 20 (S301), then the management computer 20 reads, after receiving the request, the application security level management table T201 (S302) and has the management client 50 display an application program screen (S303).

The user inputs, from the screen displayed in the management client 50, an “application program name” that uses a relevant logical volume, a “host name” and “IP address” of the application host computer where the application program runs, and “security level” required by data handled by the application program. The management client 50 makes a request, based on the user input, for the “host name” and “IP address” of the application host computer, and the “security level” required by the data handled by the application program to be registered (S304). The management computer 20 registers, after receiving the registration request, the above set content for the application security level management table T203 (S305).

Finally, the registration result concerning the application program is displayed in the management client 50 (S306). If the registration processing failed halfway through, an error message is displayed as the registration result.

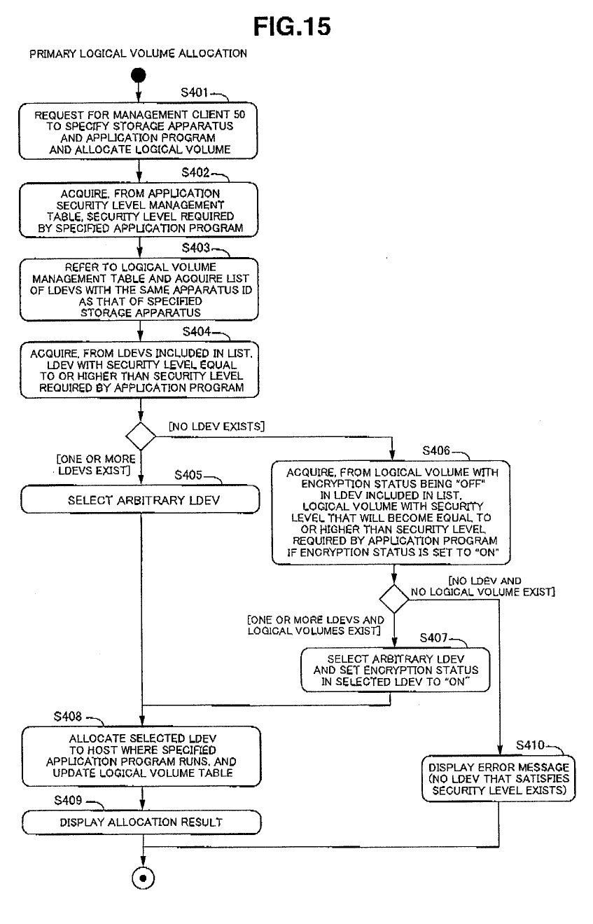

The sequence of processing for allocating a logical volume to the application host computer 30 is described with reference to FIG. 15. More specifically, in this processing, an LDEV that satisfies the security level required by the application program P30 that uses a relevant logical volume is selected from the storage apparatus 10, and the selected logical volume is allocated to the application host computer 30 where the application program 30 runs.

The management client 50 makes a request for the management computer 20 to receive user input for selecting the apparatus ID of the storage apparatus 10 that creates the relevant logical volume and the application program name of the application program P30 that uses the above logical volume, and also allocate the logical volume (S401). The management computer 20 acquires, from the application security level management table T203, the security level required by the specified application program (S402), refers to the logical volume management table T202, and acquires a list of LDEVs with the same apparatus ID as that specified by the management client S0 in step S401 based on the user input (S403). Next, the management computer 20 acquires, from the LDEVs included in the list, an LDEV with a security level equal to or higher than the security level required by the application program (S404). For example, if the security level required by the application program is B, an LDEV with the security level of A or B is acquired.

If one or more LDEVs satisfy the above conditions, an arbitrary LDEV is selected, and the processing proceeds to the next step (S405). For example, the capacity of each LDEV may also be managed in the logical volume management table T300 so that an LDEV with the larger capacity can be selected. Alternatively, an LDEV with a smaller LDEV number may be selected. Alternatively still, regardless of the number of LDEVs that satisfy the conditions, information about the acquired LDEVs may be sent to the management client 50 to present those LDEVs to the user via the management computer 50 and have the user specify an LDEV. In that case, a request for specifying an LDEV is received from the management computer 50, and an LDEV is selected according to that request. The same process is conducted in step S407 described later.

Meanwhile, if no LDEV satisfies the conditions, a logical volume with a security level that becomes higher than the security level required by the application program if the “encryption status” is set to ON is selected from the logical volumes with the “encryption status” being OFF in the LDEVs included in the list acquired in step S403 (S406). More specifically, the encryption mode and theft risk of the storage apparatus the LDEVs with the encryption status being OFF belongs to are acquired, the security level corresponding to the combination of that encryption mode and theft risk is acquired from the security level definition table T201, and a list of LDEVs with the security level equal to or higher than the security level required by the application program is acquired. If one or more LDEVs satisfy the above conditions, an arbitrary LDEV is selected, the encryption status for the selected LDEV is set to ON, and the processing proceeds to the next step (S407). Meanwhile, if no LDEV satisfies those conditions, an error message indicating that no LDEV satisfies the required security level is displayed in the management client 50 via the I/O interface 23 (S410).

If an LDEV that satisfies the conditions exists, the above selected LDEV is allocated to the host computer where the specified application program runs, and, in the logical volume management table T202 an LUN for uniquely specifying a logical volume is entered in the “LUN” entry corresponding to that LDEV, the host name of the application host computer 30 where the application program runs is entered in the “host” entry, and the specified application program name is entered in the “application program” entry to update the logical volume management table T202 (S408).

After updating the table, the allocation result is displayed in the management client 50 (S409). If the allocation processing fails halfway through, an error message is displayed as the allocation result.

Through the above described processing, a logical volume is created in a storage apparatus 10, the application host computer 30 becomes able to access the logical volume, and the application program P30 in the application host computer can use a logical volume that satisfies the required security level.

In this embodiment, a user specifies a storage apparatus when allocating a logical volume. However, the management computer may select one or more storage apparatuses where a logical volume is created based on different kinds of algorithms.

In step S404 in this embodiment, LDEVs with a security level equal to or higher than the security level required by the application program are acquired from LDEVs included in the list. However, in an environment where plural application programs run on the host computer where the application program specified in step S401 runs, the processing in steps S404-1 and S404-2 described below may be executed instead of step S404.

The management computer 20 finds, from necessary security levels required by plural application programs that run in the host computer where the application program specified in step S401 runs, the highest necessary security level based on the application security level management table T203 (S404-1). After that, based on user input in step S401, the management computer 20 acquires, from LDEVs included in the list and with the same apparatus ID as that specified by the management client 50, the LDEVs with a security level equal to or higher than the highest necessary security level found in step S404-1 (S404-2).

Through the processing of steps S404-1 and S404-2 above, the security level is guaranteed even when each of the application programs running in the same host computer uses an LDEV allocated to other application programs.

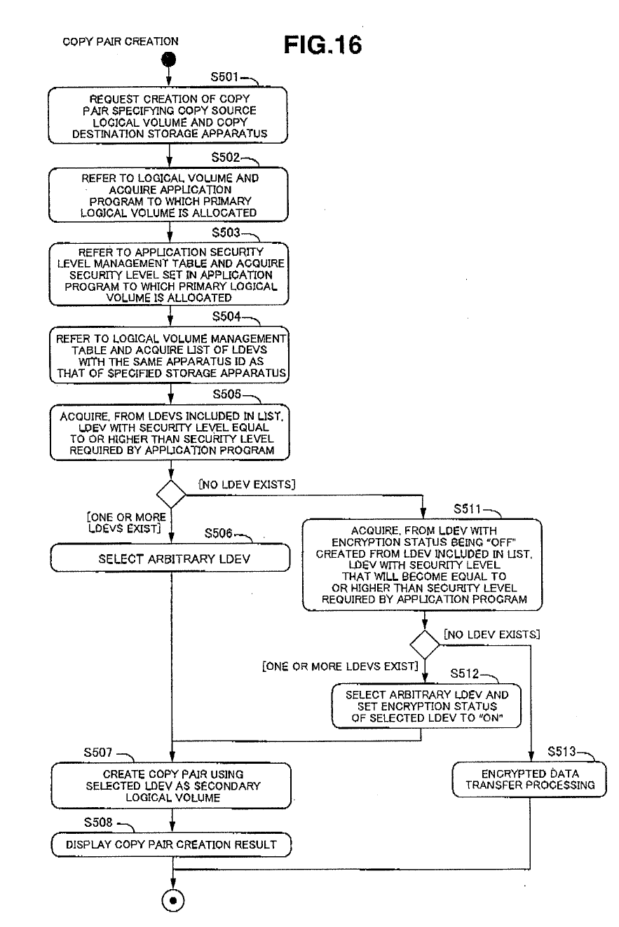

The sequence of processing for creating a copy pair is described with reference to FIG. 16. More specifically, an LDEV that satisfies the security level required by the application program P30 that uses a relevant logical volume is selected in the copy destination-side storage apparatus 10, and a copy pair is created using the logical volume used by the application program 30.

Firstly, in response to user input, the management client 50 sends, to the management computer 50, a copy pair creation request that specifies a primary logical volume copy source, and a storage apparatus that includes a copy destination logical volume (S501).

The management computer 20 refers, after receiving the copy pair creation request, to the logical volume management table T202, acquires the application program P30 the above specified primary logical volume is allocated to (S502), and acquires, from the application security level management table T203, the security level set for the application program P30 the primary logical volume is allocated to (S503).

Next, the management computer 20 refers to the logical volume management table T202 and acquires a list of LDEVs with the “apparatus ID” entry that holds the apparatus ID of the storage apparatus including the copy destination logical volume (S504), and acquires, from the LDEVs included in the list, an LDEV with a security level equal to or higher than the security level required by the application program acquired in step S503 (S505).

If one or more LDEVs are acquired in step S505, an arbitrary LDEV is selected and the processing proceeds to the next step (S506). For example, the capacity of each LDEV may also be managed in the logical volume management table T300 so that the LDEV with the largest capacity can be selected. Alternatively, the LDEV with the smallest LDEV number may be selected. Still alternatively, regardless of the number of the LDEVs acquired in step S505, information about the acquired LDEVs may be sent to the management client 50 to present those LDEVs to a user via the management computer 50 and have the user specify an LDEV. In that case, an LDEV is selected based on a request that specifies the LDEV received from the management computer 50. The same process is conducted in step S512 explained later.

Meanwhile, if no LDEV satisfies the conditions, in logical volumes with the “encryption status” entry being OFF created from the LDEVs included in the list acquired in step S504, the logical volumes with a security level that will become equal to or higher than the security level required by the application program if their “encryption status” entries are set to ON are acquired (S511).

If one or more LDEVs are acquired in step S511, an arbitrary LDEV is selected and the encryption status of the selected LDEV is set to ON, and processing proceeds to the next step (S512). Meanwhile, if no LDEV is acquired, the data to be stored in the primary logical volume is copied, keeping the data encrypted (S513). The details of step S513 will be explained later.

If an LDEV that satisfies the required security level exists, a logical volume is created in the storage apparatus the selected LDEV belongs to and a copy pair is formed with the thus created logical volume and the specified primary logical volume. After creating a copy pair, in the logical volume management table T202, an LUN for uniquely identifying the logical volume is entered in the “LUN” entry for the above created LDEV, the host name of the application host computer 30 where the application program runs is entered in the “host” entry, and the specified application program name is entered in the “application program” entry, thereby updating the logical volume management table T202 (S507). After updating the table, the copy pair creation result is displayed in the management client 50 (S508). If the copy pair creation processing has failed halfway through, an error message is displayed as the copy pair creation result.

Through the above described processing, even if, for example, the storage apparatus installed in the primary site is managed under strict security but the security level in the backup site, which may be outsourced, is assumed to be lower than that in the primary site, data can be backed up while guaranteeing the security level required by both the primary and backup sites.

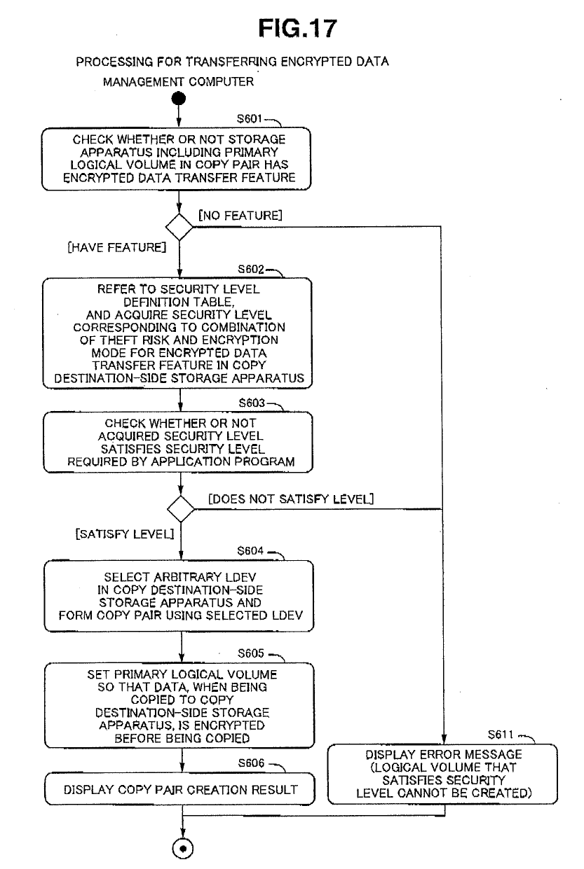

The sequence of processing for transferring encrypted data to a copy destination-side storage apparatus is described with reference to FIG. 17. Even where no LDEV satisfies the necessary security level in the copy destination-side storage apparatus, the data can be securely managed in the copy destination-side storage apparatus by copying data while keeping the data encrypted.

If no LDEV satisfies the necessary security level in the copy destination-side storage apparatus, the management computer 20 checks whether or not the storage apparatus including a primary logical volume in a relevant copy pair has the encrypted data transfer feature (S601). If not, data cannot be securely stored in the logical volume in the copy pair, so error information indicating that a secondary logical volume that satisfies the security level cannot be created is sent via the I/O interface 23 from the management computer 20 to the management client 50, and an error message is displayed in the display in the management client 50 (S611). If the storage apparatus has the encrypted data transfer feature, the management computer 20 refers to the security level definition table T201 and acquires a security level corresponding to the combination of the theft risk in the copy destination-side storage apparatus and the encryption mode set for the storage apparatus that includes the primary logical volume (S602). After acquiring that security level, the management computer 20 checks whether or not the acquired security level satisfies the security level required by the application program that uses the primary logical volume. More specifically, the management computer 20 specifies, from the “application program name” entries in the logical volume management table T202, the application program the primary logical volume is allocated to, acquires the security level required by the application program from the “necessary security level” entries in the application security level management table T203, and compares the acquired necessary security level with the security level acquired in step S602. If the security level acquired in S602 satisfies the necessary security level, the processing proceeds to step S604. If not, error information indicating that a secondary logical volume that satisfies the necessary [symbol] security level cannot be created is sent via the I/O interface 23 from the management computer 20 to the management client 50, and an error message is shown in the display in the management client 50 (S611).

If the security level acquired in step 602 satisfies the necessary security level, the management computer 20 selects an arbitrary LDEV in the copy destination-side storage apparatus, and the selected LDEV is set as a secondary logical volume. A copy pair is formed with that secondary logical volume and the specified primary logical volume. After forming the copy pair, the management computer 20 enters the LUN of the secondary logical volume in the “LUN” entry in the logical volume management table T202, the host name of the application host computer 30 where the application program runs in the “host” entry, and the specified application program name in the “application program name” entry, thereby updating the logical volume management table T202 (S604).

Finally, the management computer 20 sets the storage apparatus 10 including the primary logical volume so that when data in the primary logical volume is copied to the copy destination-side storage apparatus, the data to be copied is encrypted (S605). More specifically, the management computer 20 instructs the storage apparatus 10 via the interface 24 to encrypt data in the primary logical volume and send the encrypted data to the secondary logical volume. After that instruction, the management computer 20 has the management client 50 display a copy pair creation result (S606). If processing for the copy pair creation fails halfway through, an error message is displayed as the copy pair creation result.

Through the above described processing, even if no LDEV that satisfies the necessary security level exists in the copy destination-side storage apparatus, data can be backed up in the storage apparatus, while guaranteeing the security level.

In this processing, data transferred to the copy destination-side storage apparatus is kept encrypted. Therefore, to read or write the data from the copy destination logical volume, that data has to be read/written from the copy source storage apparatus, or via an apparatus or module having the same encryption feature as in the copy source storage apparatus.

In this embodiment, a user specifies the storage apparatus in which the copy destination logical volume is created. However, alternatively, the management computer may select, based on some kinds of algorithm, one or more storage apparatuses in which the copy destination logical volume is created.

The above is the full explanation of processing, executed when allocating a storage area in a storage apparatus 10 to the application host computer 30 or creating a copy pair, for selecting, to allocate a logical volume or create a copy pair, a storage area in the storage apparatus 10 that satisfies a security level required by the application program P30 that runs on the application host computer 30. With the above described processing, the overall storage management system, including a copy destination-side storage apparatus, can guarantee the security level required by application data and securely manage the application data.

In this embodiment, a security level is utilized when creating a logical volume or a copy pair. However, the security level may also be utilized when changing a logical volume to be allocated or a logical volume used to form a copy pair.

Alternatively, a security level may be utilized when checking whether or not an allocated logical volume or a logical volume forming a copy pair satisfies a necessary security level. More specifically, if a security level in an LDEV is updated as an encryption mode or theft risk of the storage apparatus is changed, whether or not the post-update security level satisfies the security level required by the application program using that LDEV is checked. If the security level required by the application program is updated, whether or not the security level in a logical volume associated with that application program satisfies the post-update security level is checked.

In this embodiment, a single logical volume is created from one LDEV. However, a logical volume may be created from plural LDEVs. In that case, the encryption status value and the encryption mode value of the LDEVs included in the logical volume is always fixed.

In this embodiment, a single application program runs on a single application host computer. However, plural application programs may run on one application host computer. In that case, a user establishes settings so that the application program specified when selecting the logical volume accesses a logical volume allocated to the host computer. An application program may also be one that runs on a virtual computer. In that case too, a user establishes settings so that an application program in a virtual computer accesses a logical volume allocated to the host computer.

In this embodiment, the storage apparatus includes an encryption/decryption device. However, if an encryption appliance is used, it can be used as the encryption/decryption device.

In this embodiment, the theft risk of a storage apparatus is utilized when determining the security level in an LDEV. However, the security level may also be determined only by the encryption mode in the storage apparatus, not using the theft risk. In that case, during processing for registering the storage apparatus, the management computer 20 sets a fixed value “N/A” as the theft risk, and only “N/A” is entered in the theft risk entry in the security level definition table T201. During processing for updating the security level definition, a user registers, only the security level of “N/A” in the entry corresponding to each encryption mode. As a result, the theft risk of the storage apparatus is always “N/A” and the security level is determined depending only on the encryption mode when determining the security level using the security level definition table.

### Embodiment 2

Next, embodiment 2 will be described below. In embodiment 1, only the security level is considered to allocate a logical volume or create a copy pair. Meanwhile, in embodiment 2, factors other than the security level, such as factors concerning system performance, are also considered to determine a logical volume to be allocated or a copy destination logical volume used in a copy pair.

The apparatus configuration is the same as that in embodiment 1.

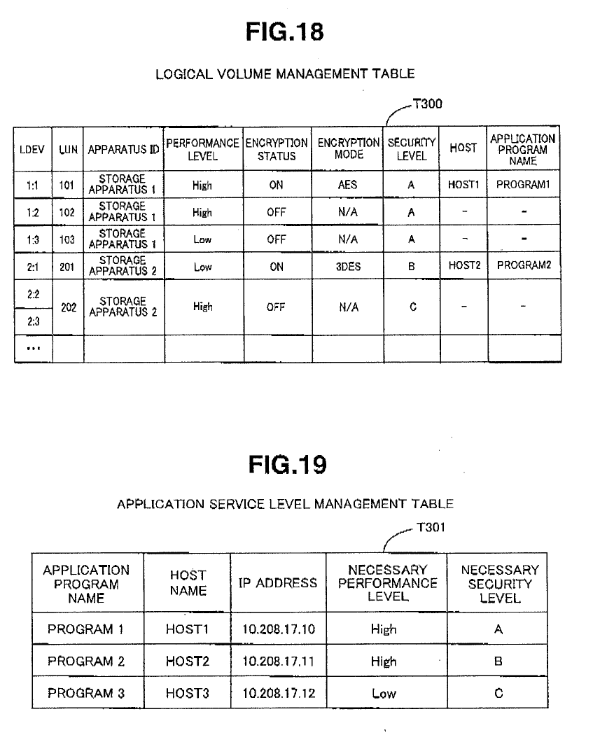

Processing executed in embodiment 2 will be described below with reference to FIGS. 18 to 20.

FIG. 18 is the logical volume management table that further contains entries of the logical volume performance level. The performance level is a value determined based on the HDD type a relevant logical volume belongs to, or the number of rotations of the HOD. This value may be manually determined by a user according to the HDD attribute, or automatically determined by a program. In FIG. 18, “High” indicates high performance, and “Low” indicates low performance.

For example, performance of logical volumes formed by an FC disk and an SCSI disk may be defined as “High” and “Low” respectively. Alternatively, if the storage apparatus includes logical volumes created with flash memory in addition to those formed with a HDD, performance of logical volumes formed by flash memory and a HDD may be defined as “High” and “Low” respectively.

FIG. 19 is the application security level management table that further includes “necessary performance level” entries that hold the performance level required by each application program. In the FIG. 19 example, the table indicates that a program 1 requires a “High” performance level and a security level of “A” or higher.

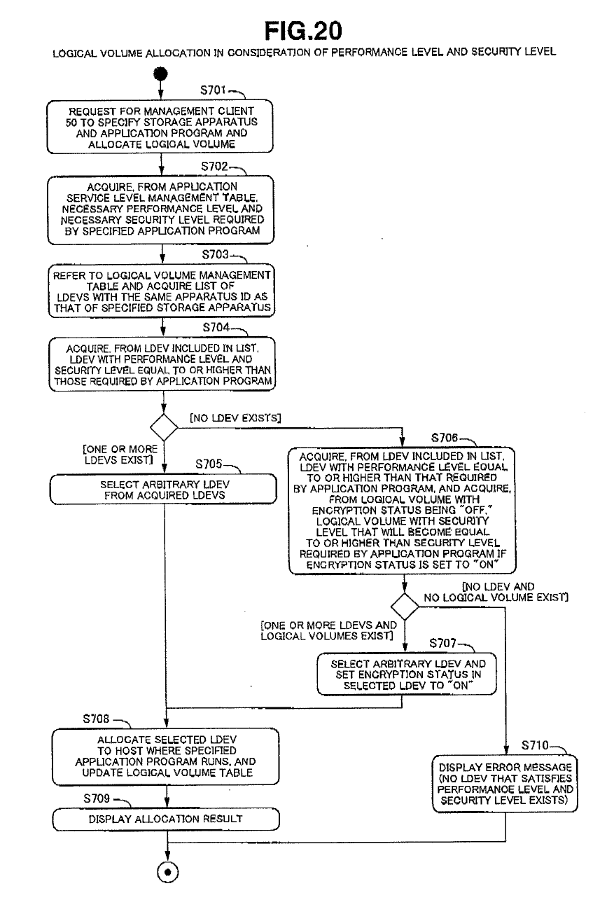

FIG. 20 illustrates processing for allocating a primary logical volume, taking the performance level into consideration. The management client 50 receives input from a user for selecting an apparatus ID of a storage apparatus 10 where a logical volume is created and an application program name of the application program P30 that uses the logical volume, and requests that this logical volume is allocated (S701). The management computer 20 acquires, from the application service level management table T301, the performance level and security level in the specified application program (S702), and acquires, referring to the logical volume management table T300, a list of LDEVs with the same apparatus ID as that specified by a user (S703). The management computer 20 then acquires, from LDEVs included in the list, an LDEV with a performance level equal to or higher than the performance level in the application program and a security level equal to or higher than the security level in the application program (S704).

If one or more LDEVs satisfy the above conditions, an arbitrary LDEV is selected and the processing proceeds to the next step (S705). Meanwhile, if no LDEV satisfies the conditions, the management computer 20 acquires, from the LDEVs included in the list acquired in step S703, an LDEV with a performance level equal to or higher than the performance level of the application program, with the “encryption status” entry being OFF, and with a security level that will become equal to or higher than the security level required by the application program if the “encryption status” entry is set to ON (S706). If one or more LDEVs satisfy those conditions, an arbitrary LDEV is selected, the encryption status of the selected LDEV is set to ON, and the processing proceeds to the next step (S707). Meanwhile, if no. LDEV satisfies the conditions, an error message indicating that no LDEV satisfies the necessary performance level and security level is displayed in the management client 50 (S710).

If at least one LDEVs satisfy the conditions, the above selected LDEV is allocated to the host computer where the specified application program runs, and the logical volume management table T300 is updated (S708). After updating the table, the allocation result is displayed in the management client 50 (S709). If the allocation processing fails halfway through, an error message is displayed as the allocation result.

Through the above described processing, a logical volume is created in the storage apparatus 10, the application host computer 30 becomes able to access that logical volume, and the application program P30 in the application host computer can use a logical volume that satisfies the required performance level and security level.

FIG. 20 illustrates processing for allocating a primary logical volume, taking the performance level into consideration. Meanwhile, processing for creating a copy pair, taking the performance level into consideration, may also be conducted in a similar manner, based on the processing illustrated in FIGS. 20 and 16.

The computer, the storage area management method in the computer, and the computer system have been explained above based on the embodiments. However, the above described embodiments of the invention are not designed to limit the scope of the invention, but facilitate understanding of the invention. For example, in the above described embodiments, the management computer 20 is connected to the application client 50 that is a computer a user inputs instructions to, and receives the user instructions via an application client. However, the management computer may be connected, via interfaces, to input devices such as a keyboard and display devices such as a monitor, and receive user instructions via the connected input devices.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. A management computer connected to plural host computers and plural storage apparatuses, each host computer being designed to execute an application program, and each storage apparatus connected to the host computers having plural logical volumes,
the management computer comprising:
memory for storing first association information for associating each application program with application security level information indicating a security level required by the application program, and second association information for associating each logical volume with logical volume security level information indicating a security level in the logical volume;
an interface for receiving a logical volume allocation request specifying an application program; and
a processor for specifying, based on the first association information, application security level information that indicates the security level required by the application program specified by the logical volume allocation request, and selecting, based on the second association information, from the plural logical volumes, a logical volume that satisfies the security level indicated by the specified application security level information.

2. The management computer according to claim 1, wherein the application security level information is information that indicates an encryption level required by an application program, and the logical volume security level information is information that indicates an encryption level in an logical volume.

3. The management computer according to claim 1, wherein the application security level information and the logical volume security information are determined based on information about an encryption level and theft risk in each storage apparatus.

4. The management computer according to claim 1, wherein the management computer is connected to a management client computer, and the interface receives the logical volume allocation request by receiving that request from the management client computer.

5. The management computer according to claim 1, wherein the interface receives a logical volume allocation request that specifies both an application program and a storage apparatus,
wherein the processor specifies, based on the first association information, application security level information that indicates the security level required by the application program specified by the logical volume allocation request, and selects, based on the second association information, a logical volume that satisfies the security level indicated by the specified application security level information from logical volumes included in the storage apparatus specified by the logical volume allocation request.

6. The management computer according to claim 1, wherein the processor selects plural logical volumes that satisfy the security level indicated by the specified application security level information, and sends via the interface, information indicating the selected logical volumes;
the interface receives a logical volume specification request for specifying a logical volume in the selected logical volumes; and
the processor allocates the logical volume specified by the logical volume specification request to a host computer that executes the application program specified by the logical volume allocation request.

7. The management computer according to claim 1, wherein if the processor selects plural logical volumes, the processor specifies an arbitrary logical volume, and allocates the specified logical volume to a host computer that executes the application program specified by the logical volume allocation request.

8. The management computer according to claim 1, wherein the first association information associates each application program with application security level information that indicates the security level required by the application program and performance level information that indicates the performance level required by the application program;
the second association information associates each logical volume with logical volume security level information that indicates the security level in the logical volume and performance level information that indicates the performance level in the logical volume; and
the processor specifies, based on the first association information, the application security level information and the performance level information about the application program specified by the logical volume allocation request, and selects, based on the second association information, from the plural logical volumes, a logical volume that satisfies the security level indicated by the specified application security level information and the performance level indicated by the specified performance level information.

9. A management computer connected to plural host computers and plural storage apparatuses, each host computer being designed to execute an application program, and each storage apparatus connected to the host computers having plural logical volumes,
the management computer comprising:
memory for storing a first table for associating each application program with application security level information that indicates a security level required by the application program, and a second table for associating each logical volume with logical volume security level information that indicates a security level in the logical volume and an application program that uses the logical volume;
an interface for receiving a copy pair creation request specifying a copy source logical volume; and
a processor for specifying, based on the second table, an application program that uses the copy source logical volume, specifying, based on the first table, security level information required by the specified application program, and selecting, based on the second table, from the plural logical volumes, a logical volume that satisfies the security level indicated by the specified security level information.

10. The management computer according to claim 9, wherein the application security level information is information that indicates an encryption level required by an application program, and the logical volume security level information is information that indicates an encryption level in a logical volume.

11. The management computer according to claim 9, wherein the application security level information and the logical volume security information are determined based on information about an encryption level and theft risk in each storage apparatus.

12. The management computer according to claim 9, wherein the interface is designed to receive a copy pair creation request that specifies both a copy source logical volume and a copy destination-side storage apparatus; and
the processor specifies, based on the second table, an application program that uses the copy source logical volume, specifies, based on the first table, application security level information that indicates the security level required by the specified application program, and selects, from logical volumes included in the copy destination-side storage apparatus, a logical volume that satisfies the security level indicated by the security level information.

13. The management computer according to claim 12, wherein the memory also stores encryption feature information that indicates whether in each storage apparatus a feature of encrypting data to be transmitted is available and a level of encryption, and
wherein if no logical volume in those included in the copy destination-side storage apparatus satisfies the security level indicated by the specified security level information, the processor selects, based on the encryption feature information and the second table, from the logical volumes included in the copy destination-side storage apparatus, a logical volume that satisfies the security level indicated by the specified security level information.

14. The management computer according to claim 13, wherein the processor instructs the storage apparatus including the copy source logical volume to encrypt data in the copy source logical volume and send the encrypted data to the selected logical volume.

15. The management computer according to claim 9,
wherein the first table associates each application program executed by each host computer with application security level information that indicates the security level required by the application program and information that indicates the performance level required by the application program;
wherein the second table associates each logical volume with volume security level information that indicates the security level in the logical volume and performance level information that indicates the performance level in the logical volume; and
wherein the processor specifies, based on the second association information, security level information and performance level information required by the specified application program, and selects, from the logical volumes, a logical volume that satisfies the security level and the performance level indicated by the specified security level information and performance level information.

16. A system including plural host computers, plural storage apparatuses, and a management computer,
wherein the host computers are connected to the storage apparatus via a first network; the host computers, the storage apparatus, and the management computer are connected mutually via a second network; each host computer is designed to execute an application program; and each storage apparatus has plural logical volumes,
wherein the management computer comprises:
memory for storing first association information for associating each application program with application security level information that indicates a security level required by the application program, and second association information for associating each logical volume with logical volume security level information that indicates a security level in the logical volume;
an interface for receiving a logical volume allocation request specifying an application program; and
a processor for specifying, based on the first association information, application security level information that indicates the security level required by the application program specified by the logical volume allocation request, and selects, based on the second association information, from the logical volumes, a logical volume that satisfies the security level indicated by the thus specified application security level information.
